(19) United States
(12) Patent Application Publication
(10) Pub. No.: US 2012/0263025 A1
(43) Pub. Date: Oct. 18, 2012

(54) OPTICAL DISC DEVICE

(75) Inventors: Tsuyoshi EIZA, Osaka (JP); Masaki Matsumoto, Osaka (JP)

(73) Assignee: FUNAI ELECTRIC CO., LTD.

(21) Appl. No.: 13/442,982

(22) Filed: Apr. 10, 2012

(30) Foreign Application Priority Data
Apr. 14, 2011 (JP) 2011-089975

(51) Int. Cl. G11B 7/095; G11B 27/36

(52) U.S. Cl. 369/44.11; G9B/7.063; G9B/27.052

(57) ABSTRACT

An optical disc device includes a tracking error signal amplitude adjuster for measuring the amplitude of a tracking error signal when an optical pickup is located at an inside peripheral location of an optical disc, and at one or more outside peripheral location, and calculating a ratio of the measured amplitude to a target amplitude as an adjustment value. The tracking controller controls tracking while adjusting the amplitude of the tracking error signal according to the adjustment value, on the basis of the current radial location of the optical pickup, and the calculated adjustment value.

This application is based on Japanese Patent Application No. 2011-089975 filed on Apr. 14, 2011, the contents of which are hereby incorporated by reference.

### BACKGROUND OF THE INVENTION

1. Field of the Invention

The present invention relates to an optical disc device.

2. Description of Related Art

Production processes for conventional optical disc devices for optical discs, such as Blu-ray discs, DVDs, CDs, and the like, involve performing an adjustment known as decentering, in which the line of travel of the optical pickup traveling in the radial direction of the disc is adjusted to pass through the center of the optical disc (see, for example, Japanese Laid-open Patent Application 2005-332530).

With conventional optical disc devices, once the decentering adjustment is performed, tracking error signal amplitude adjustment (“TE amplitude adjustment”) is performed at an inside peripheral location of the optical disc. TE amplitude adjustment refers to measuring the amplitude of the tracking error signal, and calculating an adjustment value that is a ratio of the measured amplitude and a target amplitude. In cases in which a decentering adjustment is performed, because the amplitude of the tracking error signal subsequent to adjustment is substantially the same as the target amplitude, no problems have been encountered in adjusting only an inside peripheral location, even when the adjustment value of TE amplitude adjustment at the inside peripheral location is applied when adjusting the tracking error signal at an outside peripheral location.

Because decentering adjustment necessitates that the disk device have an adjusting mechanism (for example, Japanese Laid-open Patent Application 2005-332530), and because the labor cost associated with the adjustment procedure are a problem, it has been contemplated to dispense with the adjusting mechanism, and to not perform decentering adjustments, in order to reduce costs.

However, when no decentering adjustment is performed, and the TE amplitude adjustment is performed only at an inside peripheral location, with the adjustment value at the inside peripheral location being applied to the tracking error signal at an outside peripheral location, a significant change in amplitude of the adjusted tracking error signal is observed between the inside peripheral location and the outside peripheral location (the amplitude is greater at the outside peripheral location, and changes, for example, by about 6 dB). Specifically, the amplitude of the tracking error signal subsequent to adjustment at the outside peripheral location will diverge significantly from the target amplitude. In such a case, instability of the tracking servo at outside peripheral locations may arise as a problem.

### SUMMARY OF THE INVENTION

An object of the present invention is to provide an optical disc device in which a decentering adjustment is not made in order to reduce costs; and to stabilize the tracking servo irrespective of radial location on an optical disc.

The optical disc device according to the present invention comprises:

an optical pickup capable of moving in a radial direction of an optical disc, the optical pickup having a light source for emitting a light beam, an objective lens for focusing the light beam from the light source onto a recording surface of the optical disc, and a photodetector for photoelectric conversion of reflected light from the recording surface;

a signal generator for generating a tracking error signal on the basis of an electrical signal obtained through the photoelectric conversion;

a tracking controller for controlling tracking of the objective lens on the basis of the tracking error signal; and

a tracking error signal amplitude adjuster for measuring an amplitude of the tracking error signal when the optical pickup is located at an inside peripheral location of the optical disc, and at one or more outside peripheral location, and calculating a ratio of the measured amplitude and a target amplitude, as adjustment values; wherein

the tracking controller controls tracking while adjusting the amplitude of the tracking error signal according to the adjustment values, on the basis of the current radial location of the optical pickup, and the calculated adjustment values.

According to this configuration, despite the cost reductions afforded by the optical disc device due to the lack of an adjusting mechanism for performing a decentering adjustment, and to the fact that no decentering adjustment is made, changes in amplitude of the adjusted tracking error signal in the radial direction of an optical disc can be suppressed. Consequently, the tracking servo can be stabilized irrespective of radial location on the optical disc.

While the inside peripheral location and the outside peripheral location are not intended to limit the radial location, locations to the inside peripheral side from the center of the radius of the optical disc are preferably designated as inside peripheral locations, and locations to the outside peripheral side as outside peripheral locations.

In the aforedescribed configuration, optionally, the tracking error signal amplitude adjuster calculates the adjustment value at the inside peripheral location when the optical disc has been mounted, and calculates the adjustment value at the at least one outside peripheral location during a seek operation by the optical pickup. According to this configuration, an extended processing time for mounting can be suppressed.

In the aforedescribed configuration, optionally, there is provided an approximate expression calculator for calculating an approximate expression on the basis of the calculated adjustment values; and the tracking controller adjusts the amplitude of the tracking error signal according to the adjustment values, on the basis of the current radial location of the optical pickup, and the calculated approximate expression. In particular, in terms of simplifying processing, it is preferable for the approximate expression calculator to calculate a linear approximation on the basis of the calculated adjustment values.

In the aforedescribed configuration, optionally, the tracking error signal amplitude adjuster measures the amplitude of the tracking error signal when located at an inside peripheral location and at a plurality of outside peripheral locations, and calculates the ratio of the measured amplitude and a target amplitude, as adjustment values. According to this configuration, change in amplitude of the adjusted tracking error signal, in the radial direction, can be further suppressed.

In the aforedescribed configuration, optionally, in a case in which the current radial location of the optical pickup is to the outside peripheral side from the outside peripheral location furthest to the outside peripheral side from among the at least one outside peripheral location mentioned above, the tracking controller controls tracking while adjusting the amplitude of the tracking error signal according to the adjustment values, at the peripheral location furthest to the outside peripheral side. According to this configuration, deviation in amplitude of the adjusted tracking error signal to the outside peripheral side from the peripheral location furthest to the outside peripheral side can be suppressed.

In the aforedescribed configuration, optionally, the tracking error signal amplitude adjuster calculates a first adjustment value at a first outside peripheral location, and subsequently, the tracking controller controls tracking while adjusting the amplitude of the tracking error signal according to the adjustment values, on the basis of the current radial location of the optical pickup, the adjustment value at the inside peripheral location, and the first adjustment value; and

thereafter, the tracking error signal amplitude adjuster calculates a second adjustment value at a second outside peripheral location to the outside peripheral side from the first outside peripheral location, and subsequently, the tracking controller controls tracking while adjusting the amplitude of the tracking error signal according to the adjustment values, on the basis of the current radial location of the optical pickup, the adjustment value at the inside peripheral location, and the second adjustment value.

### BRIEF DESCRIPTION OF THE DRAWINGS

FIG. 1 is a simplified schematic view showing a disc player according to an embodiment of the present invention;

FIG. 2 is a simplified view showing an optical system of an optical pickup according to an embodiment of the present invention;

FIG. 3 is a flowchart relating to a mounting process according to an embodiment of the present invention;

FIG. 4 is a flowchart relating to a seek process according to an embodiment of the present invention;

FIG. 5 is a flowchart relating to a seek process according to another embodiment of the present invention; and

FIG. 6 is a graph showing an example of a relationship of radial location, amplitude of an unadjusted tracking error signal, and amplitude of an adjusted tracking error signal.

### DETAILED DESCRIPTION OF PREFERRED EMBODIMENTS

An embodiment of the present invention is described below with reference to the drawings.

(Configuration of the Device)

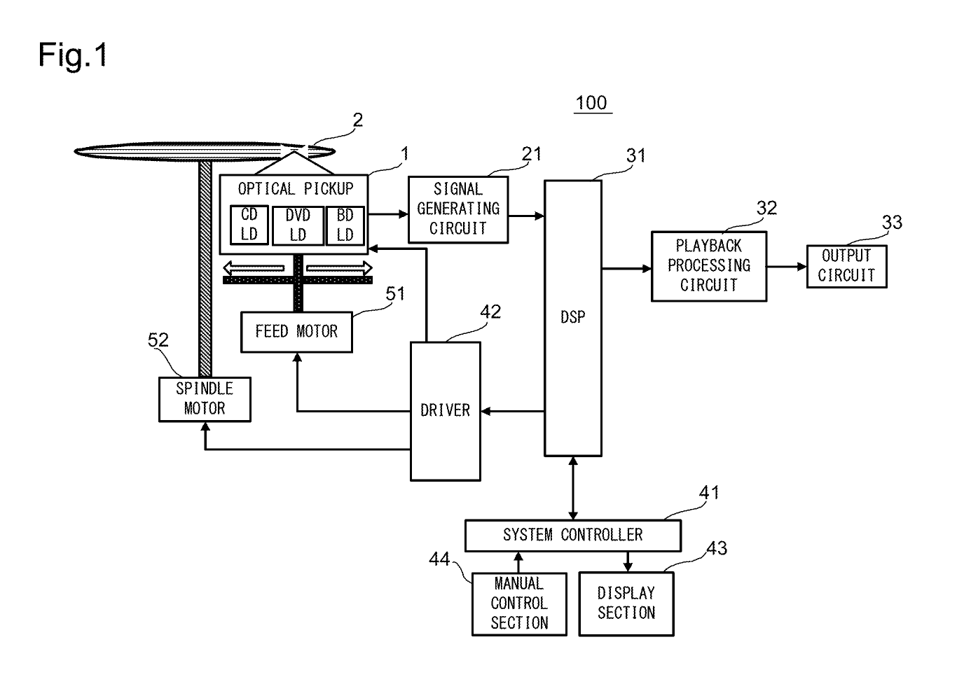

FIG. 1 is a simplified schematic view showing a disc player 100 (optical disc device) according to an embodiment of the present invention. The disc player 100 is provided with an optical pickup 1, a signal generating circuit 21, a digital signal processor (DSP) 31, a playback processing circuit 32, an output circuit 33, a system controller 41, a driver 42, a display section 43, a manual control section 44, a feed motor 51, and a spindle motor 52. The disc player 100 lacks an adjustment mechanism for performing decentering adjustments in the conventional manner.

The optical pickup 1 shines a light beam onto an optical disc 2, and reads out information of various kinds, such as audio information, video information, or the like, that has been recorded on the optical disc 2. The optical pickup 1 is furnished with a light beam for CDs, a light beam for DVDs, and a light beam for Blu-Ray discs (BD). The specifics of the inside of the optical pickup 1 will be discussed later.

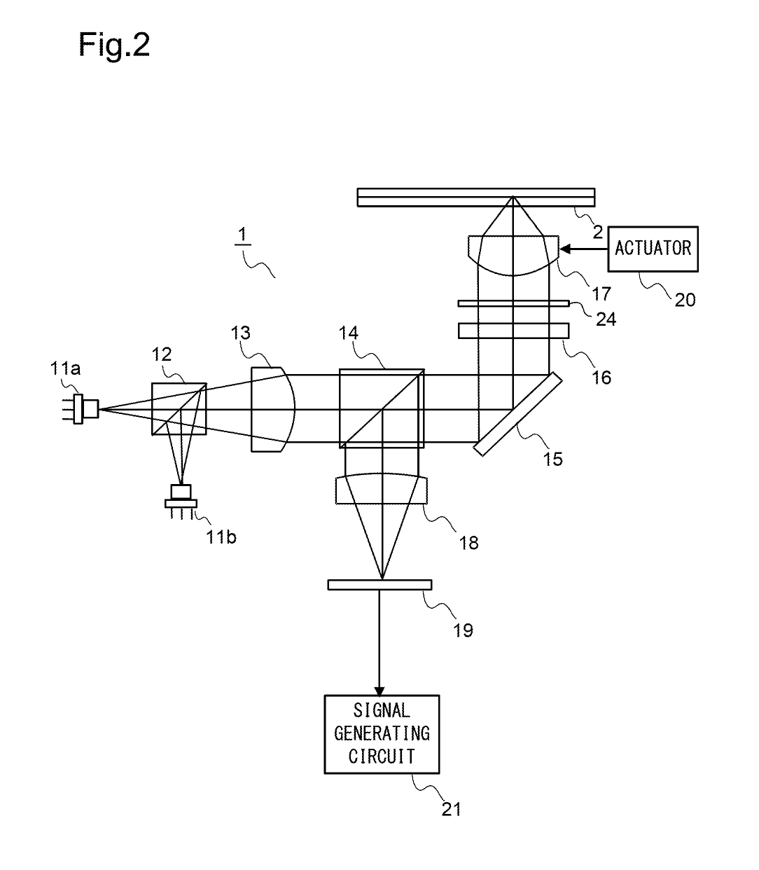

The signal generating circuit 21 performs calculation operations based on signals obtained from a photodetector 19 (FIG. 2) included in the optical pickup 1, and generates signals of various types such as an RF signal, a focus error signal, a tracking error signal, and the like. The generated signals are output to the DSP 31.

By performing image processing on the basis of the RF signal input by the signal generating circuit 21, the DSP 31 generates an image signal for presentation to the playback processing circuit 32. The playback processing circuit 32 performs a D/A conversion process in order to output the image signal to a monitor, not shown. The signal obtained from the conversion process is output by the output circuit 33 to an external device.

The DSP 31 also generates a servo signal on the basis of a focus error signal or a tracking error signal input by the signal generating circuit 21. For example, a tracking servo signal for performing a tracking servo, or a focus servo signal for performing a focus servo, is generated. The generated servo signal is presented to the driver 42. In so doing, for example, tracking control, focus control, etc., of the objective lens 17 (FIG. 2) included in the optical pickup 1 is carried out.

The system controller 41, via the DSP 31, controls the operation of the optical pickup 1, the feed motor 51, the spindle motor 52, etc. The system controller 41 is realized, for example, through execution of a predetermined program on a plurality of microprocessors or other such computational processing devices. The manual operation section 44 has various types of keys or the like, for receiving manual operation inputs from a user. The display section 43 displays various types of information such as playback status.

On the basis of a servo signal or the like presented to it by the DSP 31, the driver 42 controls driving of the optical pickup 1, the feed motor 51, and the spindle motor 52. The feed motor 51 drives the optical pickup 1 in the radial direction of the optical disc 2. The spindle motor 52 drives the optical disc 2 in a rotating direction.

(Configuration of the Optical Pickup)

FIG. 2 is a simplified view showing an optical system of the optical pickup 1 according to an embodiment of the present invention. The optical pickup 1 shines a light beam onto the optical disc 2, and receives light reflected therefrom. Information recorded on the recording face of the optical disc 2 is thereby read out.

The optical pickup 1 is provided with a first light source 11a, a second light source 11b, a dichroic prism 12, a collimating lens 13, a beam splitter 14, an upright mirror 15, a liquid crystal element 16, an objective lens 17, a detector lens 18, a photodetector 19, an actuator 20, a diffraction grating 22, a diffraction grating 23, and a quarter-wave plate 24.

The first light source 11a is a laser diode that can emit a beam in a 650 nm band corresponding to the DVD format, and a beam in a 780 nm band corresponding to the CD format. The second light source 11b is a laser diode that can emit a beam in a 405 nm band corresponding to the BD format.

In the present embodiment, an integrated, two-wavelength laser diode having two luminous points that can output light beams of two different wavelengths is employed as the first light source 11a; however, no limitation thereto is imposed; laser diodes capable, for example, of emitting only a light beam of a single wavelength may be employed as well.

The diffraction grating 22 and the diffraction grating 23 diffract the light beams sent from the first light source 11a and the second light source 11b, dividing them into a main beam and two sub-beams. This division into a main beam and sub-beams is done for the purpose of obtaining a tracking error signal employing a known technique called differential push-pull (DPP). The light beams emitted by the diffraction grating 22 and the diffraction grating 23 are sent to the dichroic prism 12.

The dichroic prism 12 transmits the light beam emitted by the first light source 11a, while reflecting the light beam emitted by the second light source 11b. The optical axes of the light beams emitted by the first light source 11a and the second light source 11b are then made coincident. The light beams transmitted or reflected by the dichroic prism 12 are sent to the collimating lens 13.

The collimating lens 13 converts the light beams emitted from the dichroic prism 12 to parallel light. The beam of parallel light created by the collimating lens 13 is sent to the beam splitter 14.

The beam splitter 14 functions as a light splitting element for splitting the impinging light beam, and is adapted to transmit the light beam sent from the collimating lens 13, to guide it towards the optical disc 2; as well as to reflect reflected light reflected from the optical disc 2 and guide it towards the photodetector 19. The light beam transmitted by the beam splitter 14 is sent to the upright mirror 15.

The upright mirror 15 reflects the light beam transmitted by the beam splitter 14, and guides it to the optical disc 2. The upright mirror 15 is inclined by 45° with respect to the optical axis of the light beam from the beam splitter 14, and the optical axis of the light beam reflected from the upright mirror 15 is approximately orthogonal to the recording face of the optical disc 2. The light beam reflected by the upright mirror 15 is sent to the liquid crystal element 16.

The liquid crystal element 16 applies a voltage to liquid crystals sandwiched between transparent electrodes (neither are illustrated), thereby utilizing the nature of the liquid crystal molecules to change orientation direction in order to control changes in refractive index, and make it possible to control the phase of the light beam transmitted by the liquid crystal element 16.

Through disposition of the liquid crystal element 16 in this way, it is possible to correct for spherical aberration arising from differences in thickness of the resin layer protecting the recording face of the optical disc 2 and the like. The light beam transmitted by the liquid crystal element 16 is sent to the quarter-wave plate 24.

The quarter-wave plate 24 has the functions of converting impinging linear polarized light to circular polarized light, as well as of converting impinging circular polarized light to linear polarized light. The light beam sent from the liquid crystal element 16 and transmitted by the quarter-wave plate 24 is converted from linear polarized light to circular polarized light, and sent to the objective lens 17.

The objective lens 17 focuses the light beam transmitted by the quarter-wave plate 24 onto the recording face of the optical disc 2. Through the actuator 20, discussed later, the objective lens 17 is moveable, for example, in the vertical direction (the perpendicular direction to the recording face of the optical disc 2) and the sideways direction (the radial direction of the optical disc 2) in FIG. 2, with the location thereof being controlled on the basis of a focus servo signal or a tracking servo signal.

Reflected light reflected from the optical disc 2 is transmitted sequentially through the objective lens 17, the quarter-wave plate 24, and the liquid crystal element 16; reflected by the upright mirror 15, then further reflected by the beam splitter 14; and focused by the detector lens 18 onto a photoreceptor element furnished on the photodetector 19.

The photodetector 19 converts the light received with photoreceptor element, such as a photodiode or the like, to an electrical signal for output to the signal generating circuit 21. The photodetector 19 is provided, for example, with a fourfold-split photoreception area for receiving a main beam, and twofold-split photoreception areas for receiving sub-beams, making it possible for photoelectric conversion to be performed and an electrical signal output, on an individual basis for each of the areas.

In accordance with an objective lens drive signal output by the driver 42 (FIG. 1), the actuator 20 moves the objective lens 17 in the radial direction of the optical disc 2. For example, the actuator 20 may pass a drive current through a coil (not illustrated) located within a magnetic field formed by a permanent magnet (not illustrated), so that the objective lens 17 can be driven through the Lorentz force.

In addition to a tracking operation to move the objective lens 17 in a direction along the recording face of the optical disc 2, the actuator 20 can also perform a tilting operation to incline the objective lens 17 so as to oscillate the optical axis of the light beam shining from the objective lens 17, or a focusing operation to move the objective lens 17 closer to or further away from the optical disc 2.

(Mounting Process)

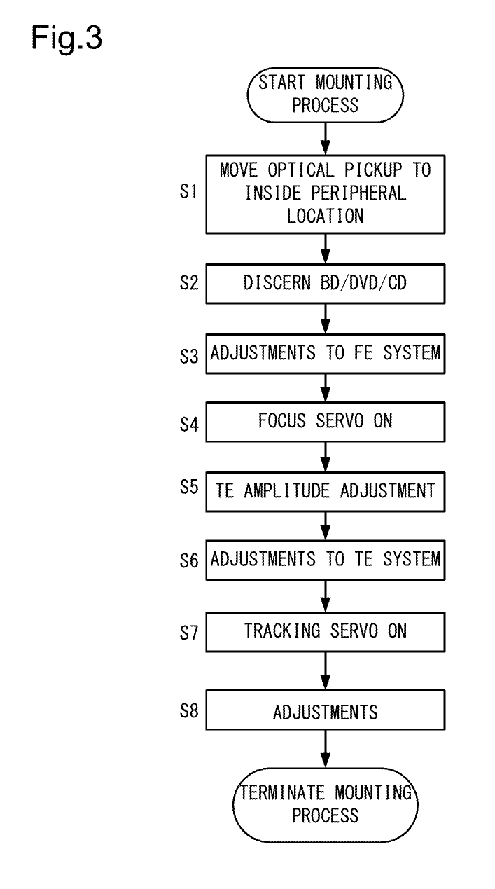

Next, a mounting process for the optical disc according to an embodiment of the present invention will be described with reference to the flowchart of FIG. 3. The process shown in FIG. 3 starts when the system controller 41 detects that the optical disc 2 has been installed in the disc player 100.

In Step S1, the system controller 41 having detected the aforedescribed event instructs the DSP 31 to move the optical pickup 1 by the feed motor 51, to an inside peripheral location of the optical disc 2. For an optical disc with a diameter of 120 mm, this inside peripheral location is a location 24 mm along the radius, for example.

Next, in Step S2, the system controller 41 instructs the DSP 31, and discerns the type of optical disc 2, i.e., BD, DVD, or CD.

Next, in Step S3, the system controller 41 performs amplitude adjustment of the focus error signal, as well as S-curve balance adjustment of the focus error signal.

Next, in Step S4, the system controller 41 instructs the DSP 31 to start a focus servo, employing the S-curve balance adjustment value obtained in the aforedescribed step. Upon receiving the instruction, the DSP 31 instructs the driver 42 to drive the actuator 20, to thereby control focusing of the objective lens 17.

Next, in Step S5, the system controller 41 performs TE amplitude adjustment. Here, the system controller 41 measures the amplitude of the tracking error signal, and calculates an adjustment value which is the ratio of the measured amplitude and a target amplitude.

Next, in Step S6, the system controller 41 carries out tracking balance adjustment, or other such adjustment of the tracking system. Further, in Step S7, the system controller 41 instructs the DSP 31 to start a tracking servo.

Further, in Step S8, the DSP 31 is instructed to carry out various adjustments subsequent to start of the tracking servo, such as focus gain adjustment or tracking gain adjustment, for example. In Step S8, the system controller 41 again carries out S-curve balance adjustment. Adjustment accuracy is improved thereby. Further, in Step S8, the system controller 41 instructs the DSP 31 to carry out various other adjustments. These adjustments may include, for example, spherical aberration adjustment, RF amplitude adjustment, tilt adjustment, RF equalizer adjustment, and the like. Once these various adjustments are completed, the mounting process terminates.

### First Embodiment of Seek Process

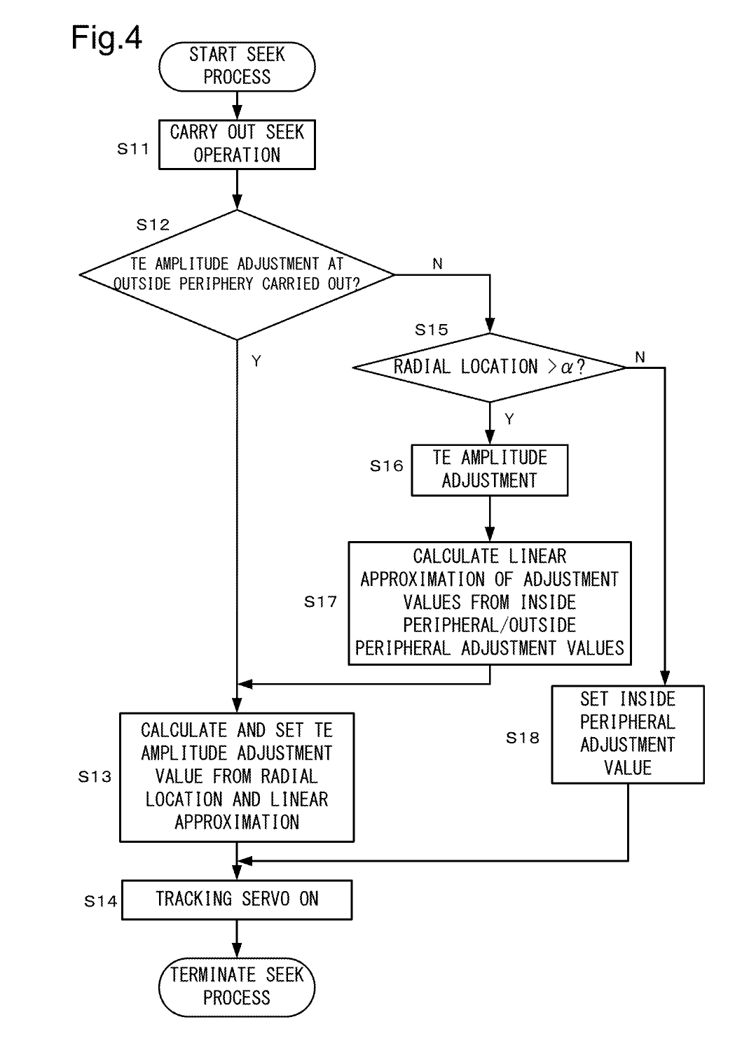

Next, an optical disc seek process according to an embodiment of the present invention is described while employing the flowchart of FIG. 4. The process shown in FIG. 4 starts when the mounting process has been completed, and an instruction to execute a seek process has been detected.

Firstly, in Step S11, the system controller 41 instructs the DSP 31 to move the optical pickup 2 in the radial direction of the optical disc 2, to a target address location on the optical disc 2, whereupon the DSP 31 controls movement of the optical pickup 1 to the target address location. A seek operation is carried out in this fashion.

Once the seek operation is completed in Step S11, the routine advances to Step S12, and the system controller 41 assesses whether TE amplitude adjustment has been carried out at an outside peripheral location. In the event this has not been carried out (N in Step S12), the routine advances to Step S15.

In Step S15, the system controller 41 calculates the current radial location of the optical pickup 2 from the target address, and assesses whether the calculated radial location exceeds a predetermined value α. Herein, in the case of an optical disc 120 mm in diameter, the predetermined value α is 40 mm, for example.

In the event that the radial location exceeds the predetermined value α (Y in Step S15), the routine advances to Step S16, and the system controller 41 carries out TE amplitude adjustment. The routine then advances to Step S17, in which the system controller 41, from the adjustment value obtained by TE amplitude adjustment performed at the inside peripheral location in the mounting process, and the adjustment value obtained by TE amplitude adjustment in Step S16 (specifically, the adjustment value at the outside peripheral location), calculates a linear approximation passing through each of the adjustment values (here and subsequently, a straight line representing the relationship of radial location and adjustment values).

Subsequent to Step S17, the routine advances to Step S13, and from the current radial location and the calculated linear approximation, the system controller 41 calculates an adjustment value corresponding to the radial location, on the linear approximation. The system controller 41 then makes a setting to the calculated adjustment value in the DSP 31.

Then, in Step S14, the system controller 41 instructs the DSP 31 to start a tracking servo. Thereupon, the DPS 31 starts the tracking servo, while adjusting the amplitude of tracking error signal by the adjustment value setting. The seek process is terminated thereby.

In the event that in Step S15, the radial location is equal to or less than the predetermined value α (N in Step S15), the routine advances to Step S18, and the system controller 41 makes a setting in the DSP 31, to the adjustment value obtained by TE amplitude adjustment that was performed at the inside peripheral location in the mounting process. Then, in Step S14, a tracking servo employing the set adjustment value is started.

Additionally, once TE amplitude adjustment has been carried out at the outside peripheral location in Step S16, thereafter, the assessment of Step S12 is that adjustment has been carried out (Y in Step S12), and the routine advances to Step S13. In Step S13, an adjustment value is calculated and set from the current radial location and the calculated linear approximation; and in Step S14, a tracking servo employing the set adjustment value is started.

According to this seek process, notwithstanding the fact that decentering adjustment is not performed, change of amplitude of the adjusted tracking error signal in the radial direction of the optical disc can be suppressed, while also stabilizing the tracking servo irrespective of radial location on an optical disc. Additionally, because TE amplitude adjustment at an outside peripheral location is performed during the seek process and not during the mounting process, the mounting process time is not prolonged.

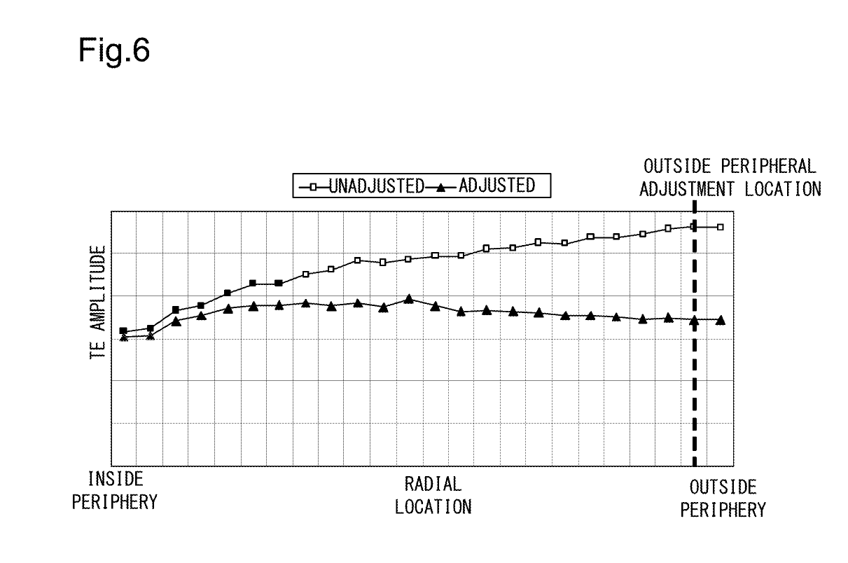

FIG. 6 shows an example of a relationship of radial location, amplitude of an unadjusted tracking error signal (the white squares), and amplitude of an adjusted tracking error signal (the black triangles). It may be appreciated from FIG. 6 that subsequent to carrying out adjustment, change in amplitude of the tracking error signal in the radial direction is suppressed (the black triangles in FIG. 6). In some cases, as shown in FIG. 6, the slope of the amplitude of the unadjusted tracking error signal is more gradual at the outside peripheral side than at the inside peripheral side (the white squares in FIG. 6). In such a case, when a linear approximation is employed to adjust the amplitude of the tracking error signal at a location further towards the outside peripheral side from the outside peripheral location where TE amplitude adjustment was performed (herein referred to as the outside peripheral adjustment location), divergence from the target amplitude tends to be observed. Accordingly, in Step S13 of FIG. 4, in a case in which a radial location lies further towards the outside peripheral side from the outside peripheral adjustment location, the adjustment value may be set to that at the outside peripheral adjustment location, rather than calculating a linear approximation (the black triangle at the right edge in FIG. 6).

### Second Embodiment of Seek Process

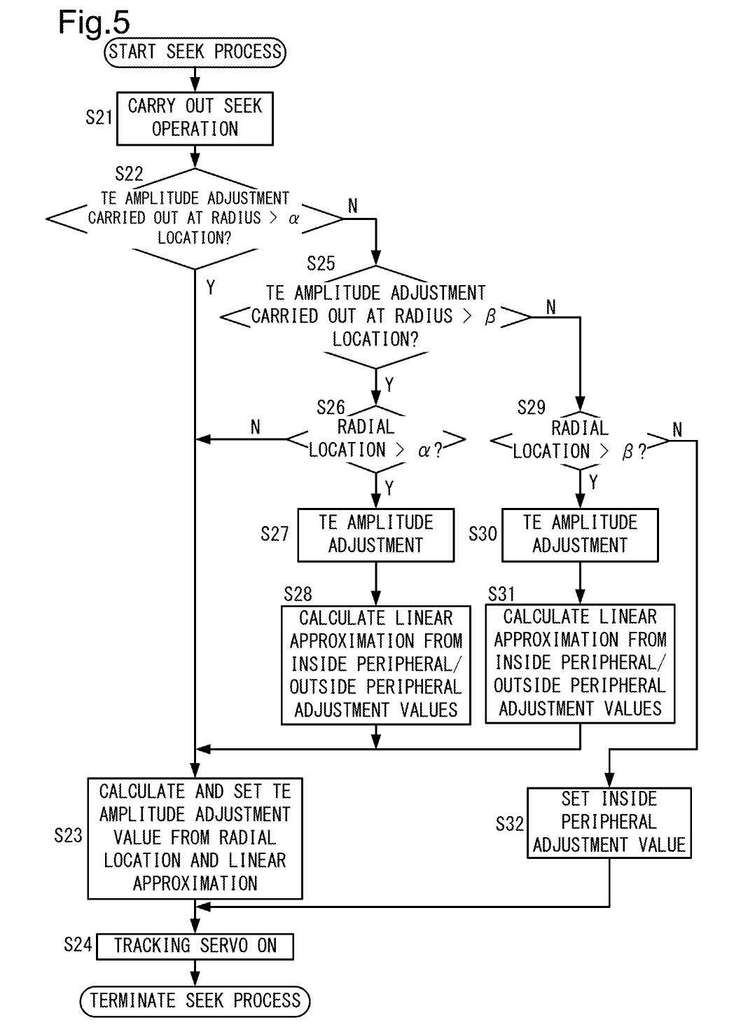

Next, an optical disc seek process according to another embodiment of the present invention is described with reference to the flowchart of FIG. 5. The process shown in FIG. 5 starts when the mounting process has been completed, and an instruction to execute a seek process has been detected. In the following description, matters comparable to those in FIG. 4 are described only briefly.

Firstly, in Step S21, a seek operation is carried out. Then, once the seek operation is completed, the routine advances to Step S22, and the system controller 41 assesses whether TE amplitude adjustment has been carried out at an outside peripheral location at which the radial location exceeds a predetermined value α. Then, in the event this has not been carried out (N in Step S22), the routine advances to Step S25. In the case of an optical disc 120 mm in diameter, the predetermined value α is 50 mm, for example.

In Step S25, the system controller 41 assesses whether TE amplitude adjustment has been carried out at an outside peripheral location at which the radial location exceeds a predetermined value β (<predetermined value α). Then, in the event this has not been carried out (N in Step S25), the routine advances to Step S29. In the case of an optical disc 120 mm in diameter, the predetermined value β is 40 mm, for example.

In Step S29, the system controller 41 calculates the current radial location of the optical pickup 2 from a target address, and assesses whether the calculated radial location exceeds the predetermined value β.

In the event that the radial location exceeds the predetermined value β (Y in Step S29), the routine advances to Step S30, and the system controller 41 carries out TE amplitude adjustment. The routine then advances to Step S31, in which the system controller 41, from the adjustment value obtained by TE amplitude adjustment performed at the inside peripheral location in the mounting process, and the adjustment value obtained by TE amplitude adjustment in Step S30 (specifically, the adjustment value at the outside peripheral location), calculates a linear approximation passing through each of the adjustment values.

Subsequent to Step S31, the routine advances to Step S23; and from the current radial location and the calculated linear approximation, the system controller 41 calculates an adjustment value corresponding to the radial location, on the linear approximation. The system controller 41 then makes a setting to the calculated adjustment value in the DSP 31.

Then, in Step S24, the system controller 41 instructs the DSP 31 to start a tracking servo. Thereupon, the DPS 31 starts the tracking servo, while adjusting the amplitude of tracking error signal by the adjustment value setting. The seek process is terminated thereby.

In the event that in Step S29, the radial location is equal to or less than the predetermined value β (N in Step S29), the routine advances to Step S32, and the system controller 41 makes a setting in the DSP 31 to the adjustment value obtained by TE amplitude adjustment that was performed at the inside peripheral location in the mounting process. Then, in Step S24, a tracking servo employing the set adjustment value is started.

In the event that, in Step S29, the radial location exceeds the predetermined value β, and moreover the radial location exceeds the predetermined value α, in a seek process thereafter, the assessment of Step S22 will be that TE amplitude adjustment has been carried out at an outside peripheral location at which the radial location exceeds the predetermined value α (Y in Step S22), and the routine will advance to Step S23.

In the event that, in Step S29, the radial location exceeds the predetermined value β but does not exceed the predetermined value α, during the next seek process, the assessment of Step S22 will be that TE amplitude adjustment has not been carried out at an outside peripheral location at which the radial location exceeds the predetermined value α (N in Step S22), and the routine will advance to Step S25. In Step S25, the assessment is that TE amplitude adjustment has been carried out at an outside peripheral location at which the radial location exceeds the predetermined value β (Y in Step S25), and therefore the routine advances to Step S26.

In Step S26, the system controller 41 assesses whether the current radial location of the optical pickup 2 exceeds the predetermined value α. In the event that the location is equal to or less than the predetermined value α (N in Step S26), the routine advances to Step S23, and an adjustment value is calculated and set from the currently calculated linear approximation.

In the event that, in Step S26, the radial location exceeds the predetermined value α (Y in Step S26), the routine advances to Step S27, and the system controller 41 carries out TE amplitude adjustment. The routine then advances to Step S28, in which the system controller 41, from the adjustment value obtained by TE amplitude adjustment performed at the inside peripheral location in the mounting process, and the adjustment value obtained by TE amplitude adjustment in Step S27 (specifically, the adjustment value at the outside peripheral location), calculates a linear approximation passing through each of the adjustment values. The routine then advances to Step S23. In a subsequent seek process, the assessment in Step S22 is “Y,” and therefore the routine advances to Step S23, in which an adjustment value is calculated and set from the most recently calculated linear approximation.

Upon advance to Step S23 following an assessment of “Y” in Step S22, in Step S23, in a case in which the current radial location lies to the outside peripheral side of the outside peripheral location, exceeding the predetermined value α, where TE amplitude adjustment was performed (herein referred to as the outside peripheral adjustment location), the adjustment value may be set to that at the outside peripheral adjustment location, instead of calculation employing a linear approximation.

In Step S28 of FIG. 5, a linear approximation passing through each of the adjustment values may be calculated from the adjustment value obtained by TE amplitude adjustment in Step S30, and the adjustment value obtained by TE amplitude adjustment in Step S27. Specifically, at this point in time, a polygonal line composed of two linear approximations is calculated. Then, during a seek process thereafter, the assessment in Step S22 is “Y,” and the routine advances to Step S23; however, in this case, an adjustment value will be calculated and set from the current radial location and the aforedescribed polygonal line. In so doing, the change in amplitude of the adjusted tracking error signal in the radial direction can be better suppressed.

### MODIFICATION EXAMPLES

While the present invention has been described in terms of a presently preferred embodiment, various modifications are possible within the scope and spirit of the present invention.

For example, whereas in the aforedescribed embodiment, linear approximations of adjustment values are calculated, multi-dimensional approximated curves, logarithmic approximated curves, or the like may be calculated as well.

Additionally, for example, rather than calculating a linear approximation in Step S17 of FIG. 4, in Step S13, an adjustment value corresponding to current radial location could be calculated directly from the current radial location, an adjustment position/adjustment value at the inside peripheral side, and an adjustment position/adjustment value at the outside peripheral side, without calculating a linear approximation.

Additionally, whereas the aforedescribed embodiment described an example of a disc player for playback of optical discs, the present invention is applicable, for example, to a BD recorder that records optical discs.

What is claimed is:

1. An optical disc device, comprising:
an optical pickup capable of moving in a radial direction of an optical disc, the optical pickup having a light source for emitting a light beam, an objective lens for focusing the light beam from the light source onto a recording surface of the optical disc, and a photodetector for photoelectric conversion of reflected light from the recording surface;
a signal generator for generating a tracking error signal on the basis of an electrical signal obtained through the photoelectric conversion;
a tracking controller for controlling tracking of the objective lens on the basis of the tracking error signal; and
a tracking error signal amplitude adjuster for measuring an amplitude of the tracking error signal when the optical pickup is located at an inside peripheral location of the optical disc, and at one or more outside peripheral location, and calculating a ratio of the measured amplitude and a target amplitude, as adjustment values; wherein
the tracking controller controls tracking while adjusting the amplitude of the tracking error signal according to the adjustment values, on the basis of the current radial location of the optical pickup, and the calculated adjustment values.

2. The optical disc device of claim 1, wherein
the tracking error signal amplitude adjuster calculates the adjustment value at the inside peripheral location when the optical disc has been mounted, and calculates the adjustment value at the at least one outside peripheral location during a seek operation by the optical pickup.

3. The optical disc device of claim 1, comprising
an approximate expression calculator for calculating an approximate expression on the basis of the calculated adjustment values; wherein
the tracking controller adjusts the amplitude of the tracking error signal according to the adjustment values, on the basis of the current radial location of the optical pickup, and the calculated approximate expression.

4. The optical disc device of claim 3, wherein
the approximate expression calculator calculates a linear approximation on the basis of the calculated adjustment values.

5. The optical disc device of claim 1, wherein
the tracking error signal amplitude adjuster measures the amplitude of the tracking error signal when located at an inside peripheral location and at a plurality of outside peripheral locations, and calculates the ratio of the measured amplitude and a target amplitude, as adjustment values.

6. The optical disc device of claim 1, wherein
in a case in which the current radial location of the optical pickup is to the outside peripheral side from the outside peripheral location furthest to the outside peripheral side from among the at least one outside peripheral location, the tracking controller controls tracking while adjusting the amplitude of the tracking error signal according to the adjustment values, at the peripheral location furthest to the outside peripheral side.

7. The optical disc device of claim 1, wherein
the tracking error signal amplitude adjuster calculates a first adjustment value at a first outside peripheral location, and subsequently, the tracking controller controls tracking while adjusting the amplitude of the tracking error signal according to the adjustment values, on the basis of the current radial location of the optical pickup, the adjustment value at the inside peripheral location, and the first adjustment value; and
thereafter, the tracking error signal amplitude adjuster calculates a second adjustment value at a second outside peripheral location to the outside peripheral side from the first outside peripheral location, and subsequently, the tracking controller controls tracking while adjusting the amplitude of the tracking error signal according to the adjustment values, on the basis of the current radial location of the optical pickup, the adjustment value at the inside peripheral location, and the second adjustment value.
